(19) United States
(12) Patent Application Publication
(10) Pub. No.: US 2013/0046703 A1
(43) Pub. Date: Feb. 21, 2013

(54) Smart Communications for Power Consumption Information

(71) Applicants: Ashok Ambati, Hyderabad (IN); Kunal K. Korgaonkar, Bangalore (IN); Mukundan Madhavan, Bangalore (IN); Ramana V. Polavarapu, Bangalore (IN)

(72) Inventors: Ashok Ambati, Hyderabad (IN); Kunal K. Korgaonkar, Bangalore (IN); Mukundan Madhavan, Bangalore (IN); Ramana V. Polavarapu, Bangalore (IN)

(73) Assignee: INTERNATIONAL BUSINESS MACHINES CORPORATION, Armonk, NY (US)

(21) Appl. No.: 13/213,254

(22) Filed: Aug. 19, 2011

(51) Int. Cl. G06Q 50/00

(52) U.S. Cl. 705/319

(57) ABSTRACT

A method, an apparatus and an article of manufacture for communicating power consumption information. The method includes comparing power consumption information of at least one user with power consumption information of at least one peer user to generate a ranking of each user in order of power consumption, monitoring the user power consumption derived from non-smart appliance usage and to generate a recommendation pertaining to at least one smart appliance for the at least one user, and publishing the generated ranking and recommendation information to a network for communication with the at least one user.

### FIELD OF THE INVENTION

Embodiments of the invention generally relate to information technology, and, more particularly, to electricity consumption analytics.

### BACKGROUND OF THE INVENTION

Utility companies go through shortages during peak times. Because peak times generally do not exceed more than 25% of a typical day, it is not prudent to build capacity to meet the peak time demand 100%. Accordingly, utility companies have an incentive to encourage the adoption of systems such as a smart grid that can better measure and manage a household's electricity consumption.

In this respect, there is also a need to provide incentives to consumers to adapt to smart grid. The incentives need not necessarily be exclusively financial. When grid experiences excessive demand, price alone cannot always yield the desired results. Consumers can also be motivated by how they are perceived, such as, via an illustration of average electricity consumption figures for a particular population.

### SUMMARY OF THE INVENTION

In one aspect of the present invention, techniques for smart communications for power consumption information are provided. An exemplary computer-implemented method for communicating power consumption information can include steps of comparing power consumption information of at least one user with power consumption information of at least one peer user to generate a ranking of each user in order of power consumption, monitoring the user power consumption derived from non-smart appliance usage and to generate a recommendation pertaining to at least one smart appliance for the at least one user, and publishing the generated ranking and recommendation information to a network for communication with the at least one user.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques for communicating power consumption information, according to an embodiment of the invention; and

FIG. 3 is a system diagram of an exemplary computer system on which at least one embodiment of the invention can be implemented.

### DETAILED DESCRIPTION OF EMBODIMENTS

As described herein, an aspect of the present invention includes implementations of smart utility meters with smart communication strategies. One or more embodiments of the invention include the use of mechanisms involving elements of social networks and “peer pressure” to incentivize the use of smart devices/appliances. Additionally, an aspect of the invention attempts to increase the confidence of users in comparative systems and increase the accuracy of such systems by generating more accurate metrics for fair comparison of electricity consumption between members of a social network and concrete recommendations that can potentially lead to further reduction in electricity consumption.

An example embodiment of the invention can include using a social network such as Facebook to encourage adoption of smart appliances by consumers. This can involve the generation of an application (an “app”) that compares or ranks network contacts based on lower electricity bills. The techniques detailed herein additionally include providing concrete suggestions (for example, pertaining to smart appliances or uses thereof) to users based on consumption patterns to facilitate an increase in the use of smarter appliances in households. Also, an aspect of the invention includes using analytics to ensure accuracy of usage feedback data sent to a consumer to increase confidence in such suggestion systems.

As described herein, utilizing social networks to communicate and present/visualize a user's electricity bill/consumption can include the following aspects. A peer ranking system can be implemented to compare usage pattern of a user with that of his or her peers (for example, in a social network) and to generate a ranking in order of consumption. This usage can be correlated with the smart appliance count of each user. The community aspects of power consumption reporting can facilitate changes in consumption patterns.

Accordingly, one aspect of the invention includes introducing a new dimension to smart homes, namely, social integration to the Web through harnessing an existing social networking service (SNS). The system detailed herein enables owners of smart devices/applicants to easily share information pertaining thereto on the Web.

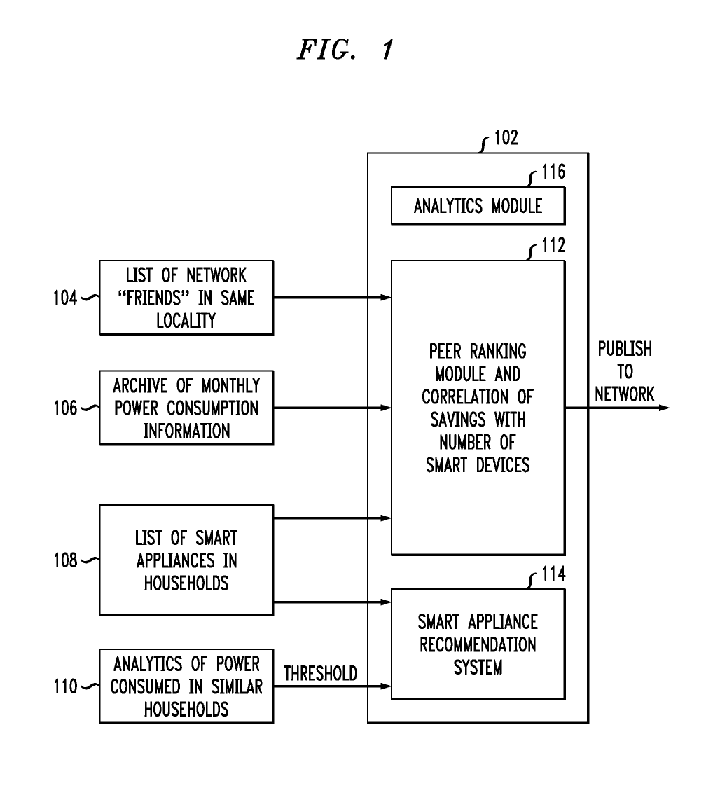

FIG. 1 is a block diagram illustrating an example embodiment, according to an aspect of the invention. By way of illustration, FIG. 1 depicts a social network application module 102 which includes a peer ranking module 112, an analytics module 116 and a smart appliance recommendation module 114. As also depicted in FIG. 1, a list of network “friends” in a same locality 104 is input to the peer ranking module 112, along with an archive of monthly power consumption information 106 and a list of smart appliances in relevant households 108. This list 108 as well as analytics of power consumed in the relevant/similar households 110 is input to the smart appliance recommendation module 114.

The peer ranking module 112 compares usage of a person with that of his or her peers and ranks the users in order of consumption. The peer ranking module 112 also correlates this usage with the smart appliance count of each user. The smart appliance recommendation module 114 monitors the non-smart-appliance portion of each user's power consumption and uses analytics based on this to intelligently recommend specific smart devices/appliances to each user. By way of example, from all of the smart appliances deployed in homes that the utility company supplies power to, an array of all smart appliances (SmartApplianceList) can be created. The cost savings for each smart appliance is calculated, with historical data from conventional appliances and smart appliances used for the calculation. Data is stored in another array (CostSavingList), and data can be calculated on a per person basis.

For all homes, the current set of smart appliances installed is held in an array of installed appliances (ApplianceInstalled). For a particular home, the list is addressed by indexing into the array ApplianceInstalled[HomeInstance]. The smart appliances typically installed in homes with the same profile as the home under consideration is held in an array of appliance profiles (ApplianceProfile). For a particular profile, the list is addressed by indexing into the array ApplianceProfile[ProfileInstance]. When the power consumption for a particular home is over the threshold for homes with that profile, the list of appliances for homes with that profile is retrieved. The appliances in that list that are not currently installed in the home under consideration become part of the recommendation list along with the cost savings for each recommended appliance retrieved from CostSavingList.

Further, the analytics module 116 facilitates the noted usage comparisons, as additionally detailed herein. The social network application module 102 ultimately publishes to generated information to a network.

An aspect of the invention can also include a model component, an archive component, a comparator component and a view component. A model component contains charges with smart meters, and also contains charges that would have accrued had the smart meters not been deployed. An archive component includes a history of consumption patterns of the consumers. A comparator component gathers relevant consumption patterns related to a user community, and a view component can generate various views, widgets, apps, etc. Also, in addition to ranking users, an aspect of the invention can include correlating power savings of users with the number of smart appliances in each user's household, thus demonstrating the power of smart appliances.

As detailed herein, one or more embodiments of the invention additionally include innovative ways of presenting bills such that consumers instantly realize the contributions of smart meters. Accordingly, an aspect of the invention includes electric bill visualization. In general, simply presenting an amount is unlikely to motivate a user to take any positive and/or desirable action with respect to adopting smart appliances.

By way of merely example, it is observed that five trees are required to absorb one ton of carbon dioxide (CO₂). A smart bill in accordance with an example embodiment of the invention can show the number of trees corresponding to the power savings of the user in question. These trees can be shown, for example, in a regular bill, on a web site or in a smart application developed for a smart phone or similar device. Additionally, for example, whenever power savings reach 0.2 tons of CO₂, an alert can be sent to the user in the image of a tree.

An aspect of the invention can also include electric bill presentation. Similarly, by way of merely one example embodiment of the invention, monetary savings (via use of smart appliances) can be illustrated with a slot machine style application. For instance, whenever a user checks his or her savings, a bill presenting application can mimic a slot machine and show the savings as winnings.

Additionally, an aspect of the invention can also include bill presentation with historical perspective. By way of example, a bill can be presented normally in numbers but with a historical perspective. In such an example scenario, an embodiment of the invention can illustrate how the user is performing compared to his or her prior records.

An aspect of the invention can additionally include bill presentation with peer pressure. Accordingly, one embodiment of the invention includes illustrating how a user is performing compared to the people in his or her social network. If access is denied to the social network of the user or the user does not belong to any social network, a user's bill can be presented against the user's community (village or town in which he or she lives).

Bill presentation with alerts is also included in one or more embodiments of the invention. According to preferences set by the user, an aspect of the invention can include sending alerts as and when certain events are observed. For example, once a user's savings result in reducing one ton of CO₂, a congratulatory alert can be sent out.

Further, as described herein, another aspect of the invention includes recommending specific smart appliances based on consumption patterns. If a customer has smart appliances for some devices, an embodiment of the invention can find the share of smart devices in his/her total consumption. If the remaining consumption (due to non-smart devices) is above a threshold, the presence of power-consuming devices such as a refrigerator or an air conditioner (AC) that are not smart appliances can be inferred. By identifying commonly used high-power consuming devices in a region (refrigerator, AC, geyser, etc.), an embodiment of the invention can provide recommendations for smart appliances for these commonly used utilities and the corresponding potential savings achievable by adopting those appliances. In an example embodiment of the invention, the threshold used above can be estimated by analyzing the average power consumption of households of similar size and with similar number of smart appliances to the user under consideration.

As also described herein, an aspect of the invention can also include analytics to generate accurate data for comparing peers. As noted, power companies may typically provide users with comparison of their power consumption with the local average consumption. However, this comparison can be misleading because it does not account for the differences in the types of households. For example, if a set of users are on vacation for an entire month, it is misleading to include them in the average computation. Other such factors can include the size of the household, number of inhabitants, etc.

By providing inaccurate comparisons, there is a greater chance that users will lose confidence in the reported data comparisons, which are used as the basis for recommendations, etc. Accordingly, one or more embodiments of the invention include improving the reliability of these comparisons by implementing metrics for use in such comparisons based on analytics on the large repository of data with the power companies. Many analytic techniques can be used to normalize for the variations between households. By way of illustration, consider the following example.

Consider a comparison between households normalized by the number of inhabitants. Because it is unfair/inaccurate to equate the savings of a small household with a larger household, this example embodiment proposes that the power saving be represented per member of the household. Also, as noted, it is undesirable to compare the power savings on the days that household members are, say, on vacation. Accordingly, the electricity usage data can be analyzed to find whenever a user sets his or her smart appliances to vacation mode. The consumption on these days will not be part of the comparison process. Based on these considerations, an example metric used to compare users could be as follows:

$$\frac{Power consumed by Household on days of non \text{-} vacation}{Number of household members}$$

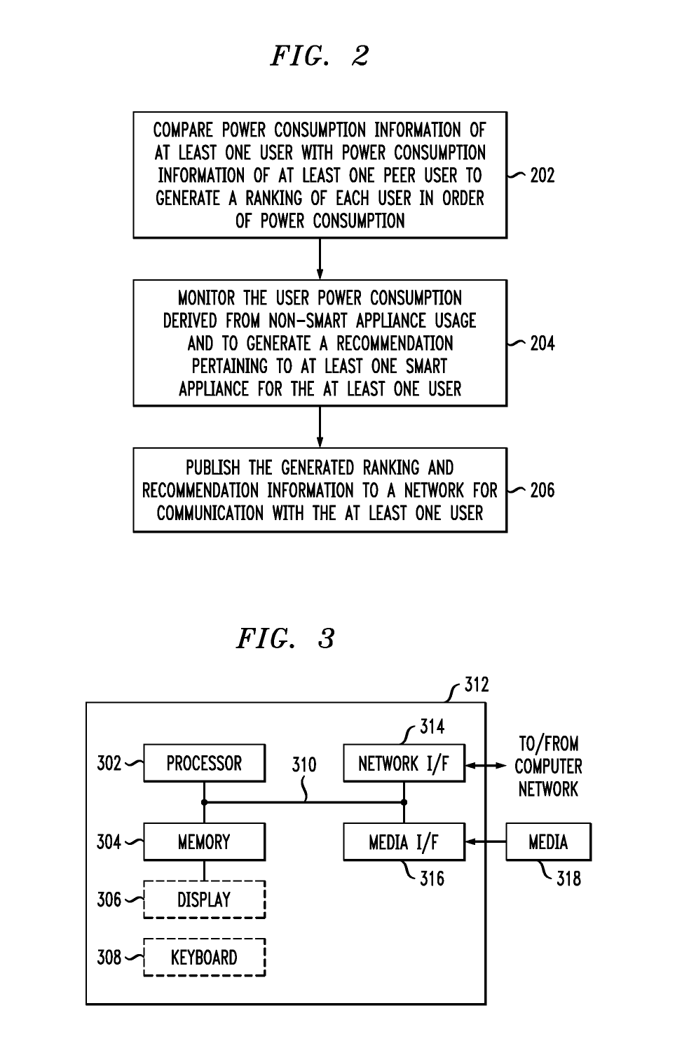

FIG. 2 is a flow diagram illustrating techniques for communicating power consumption information, according to an embodiment of the present invention. Step 202 includes comparing power consumption information of at least one user with power consumption information of at least one peer user (for example, peer(s) from a social network) to generate a ranking of each user in order of power consumption. This step can be carried out, for example, using a peer ranking module. Comparing power consumption information of at least one user with power consumption information of peer users to generate a ranking of each user in order of power consumption includes correlating power consumption information with a smart appliance count of each user.

Additionally, comparing power consumption information of at least one user with power consumption information of peer users to generate a ranking of each user in order of power consumption can also include using analytics to generate accurate comparison data, wherein the analytics normalize for at least one variation between users.

Step 204 includes monitoring the user power consumption derived from non-smart appliance usage and to generate a recommendation pertaining to at least one smart appliance for the at least one user. This step can be carried out, for example, using a smart appliance recommendation module. Monitoring the user power consumption derived from non-smart appliance usage and to generate a recommendation pertaining to smart appliances for the at least one user includes determining a share of smart devices in a user's total consumption. Additionally, an embodiment of the invention includes determining if a portion of a user's total consumption due to non-smart devices is above a threshold, and inferring presence of a non-smart power-consuming device based on this portion of total consumption.

Step 206 includes publishing the generated ranking and recommendation information to a network for communication with the at least one user. Publishing the generated ranking and recommendation information to a network for communication with users includes providing electric bill presentation. Providing electric bill presentation can include presenting an electric bill with historical perspective, community information and/or alerts.

The techniques depicted in FIG. 2 also include inputting a list of network peer users in a same locality, an archive of power consumption information and a list of smart appliances in relevant households to a peer ranking module. Additionally, an aspect of the invention includes inputting a list of smart appliances in relevant households and at least one analytic of power consumed in the relevant households to a smart appliance recommendation module. Further, the techniques depicted in FIG. 2 can include generating visual manifestations (views, widgets, apps, etc.) of the power consumption information (for example, for electric bill visualization).

As also detailed herein, embodiments of the invention include using conventional computer systems, historical data and smart meters together to carry out noted bill computation and visualization.

The techniques depicted in FIG. 2 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In an aspect of the invention, the modules include a peer ranking module, an analytics module and a smart appliance recommendation module that can run, for example on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in an associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 1. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one aspect of the present invention may provide a beneficial effect such as, for example, offering comparisons of energy saving performance against people in a user's social network as opposed to a group of unknown similar people.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for communicating power consumption information, wherein the method comprises:
comparing power consumption information of at least one user with power consumption information of at least one peer user to generate a ranking of each user in order of power consumption;
monitoring the user power consumption derived from non-smart appliance usage and to generate a recommendation pertaining to at least one smart appliance for the at least one user; and
publishing the generated ranking and recommendation information to a network for communication with the at least one user;
wherein at least one of the steps is carried out by a computer device.

2. The method of claim 1, wherein the at least one peer user comprises at least one peer from a social network.

3. The method of claim 1, wherein monitoring the user power consumption derived from non-smart appliance usage and to generate a recommendation pertaining to at least one smart appliance for the at least one user comprises determining a share of smart devices in a user's total consumption.

4. The method of claim 3, further comprising:
determining if a portion of a user's total consumption due to non-smart devices is above a threshold; and
inferring presence of a non-smart power-consuming device based on this portion of total consumption.

5. The method of claim 1, further comprising:
inputting a list of network peer users in a same locality, an archive of power consumption information and a list of smart appliances in at least one relevant household to a peer ranking module.

6. The method of claim 1, further comprising:
inputting a list of smart appliances in at least one relevant household and at least one analytic of power consumed in the at least one relevant household to a smart appliance recommendation module.

7. The method of claim 1, wherein comparing power consumption information of at least one user with power consumption information of at least one peer user to generate a ranking of each user in order of power consumption comprises correlating power consumption information with a smart appliance count of each user.

8. The method of claim 1, further comprising:
generating at least one visual manifestation of the power consumption information.

9. The method of claim 1, wherein publishing the generated ranking and recommendation information to a network for communication with the at least one user comprises providing electric bill presentation.

10. The method of claim 9, wherein providing electric bill presentation comprises presenting an electric bill with at least one of historical perspective, community information and at least one alert.

11. The method of claim 1, wherein comparing power consumption information of at least one user with power consumption information of at least one peer user to generate a ranking of each user in order of power consumption comprises using at least one analytic to generate accurate comparison data, wherein the at least one analytic normalize for at least one variation between users.

12. The method of claim 1, further comprising:
providing a system, wherein the system comprises at least one distinct software module, each distinct software module being embodied on a tangible computer-readable recordable storage medium, and wherein the at least one distinct software module comprises a peer ranking module, an analytics module and a smart appliance recommendation module executing on a hardware processor.

13. An article of manufacture comprising a computer readable storage medium having computer readable instructions tangibly embodied thereon which, when implemented, cause a computer to carry out a plurality of method steps comprising:
comparing power consumption information of at least one user with power consumption information of at least one peer user to generate a ranking of each user in order of power consumption;
monitoring the user power consumption derived from non-smart appliance usage and to generate a recommendation pertaining to at least one smart appliance for the at least one user; and
publishing the generated ranking and recommendation information to a network for communication with the at least one user.

14. The article of manufacture of claim 13, wherein the at least one peer user comprises at least one peer from a social network.

15. The article of manufacture of claim 13, wherein monitoring the user power consumption derived from non-smart appliance usage and to generate a recommendation pertaining to at least one smart appliance for the at least one user comprises determining a share of smart devices in a user's total consumption.

16. The article of manufacture of claim 15, wherein the computer readable instructions which, when implemented, further cause a computer to carry out a method step comprising:
determining if a portion of a user's total consumption due to non-smart devices is above a threshold; and
inferring presence of a non-smart power-consuming device based on this portion of total consumption.

17. The article of manufacture of claim 13, wherein the computer readable instructions which, when implemented, further cause a computer to carry out a method step comprising:
inputting a list of network peer users in a same locality, an archive of power consumption information and a list of smart appliances in at least one relevant household to a peer ranking module.

18. The article of manufacture of claim 13, wherein the computer readable instructions which, when implemented, further cause a computer to carry out a method step comprising:
inputting a list of smart appliances in at least one relevant household and at least one analytic of power consumed in the at least one relevant household to a smart appliance recommendation module.

19. A system for communicating power consumption information, comprising:
at least one distinct software module, each distinct software module being embodied on a tangible computer-readable medium;
a memory; and
at least one processor coupled to the memory and operative for:
comparing power consumption information of at least one user with power consumption information of at least one peer user to generate a ranking of each user in order of power consumption;
monitoring the user power consumption derived from non-smart appliance usage and to generate a recommendation pertaining to at least one smart appliance for the at least one user; and
publishing the generated ranking and recommendation information to a network for communication with the at least one user.

20. The system of claim 19, wherein the at least one peer user comprises at least one peer from a social network.

21. The system of claim 19, wherein the at least one processor coupled to the memory operative for monitoring the user power consumption derived from non-smart appliance usage and to generate a recommendation pertaining to at least one smart appliance for the at least one user is further operative for determining a share of smart devices in a user's total consumption.

22. The system of claim 21, wherein the at least one processor coupled to the memory is further operative for:
determining if a portion of a user's total consumption due to non-smart devices is above a threshold; and
inferring presence of a non-smart power-consuming device based on this portion of total consumption.

23. The system of claim 19, wherein the at least one processor coupled to the memory is further operative for:
inputting a list of network peer users in a same locality, an archive of power consumption information and a list of smart appliances in at least one relevant household to a peer ranking module.

24. The system of claim 19, wherein the at least one processor coupled to the memory is further operative for:
inputting a list of smart appliances in at least one relevant household and at least one analytic of power consumed in the at least one relevant household to a smart appliance recommendation module.
